(19) United States
(12) Patent Application Publication
(10) Pub. No.: US 2011/0216307 A1
(43) Pub. Date: Sep. 8, 2011

(54) High Density Wind Velocity Data Collection for Wind Turbine

(75) Inventors: Frederick C. Belen, JR., Oak Hill, VA (US); Philip L. Rogers, Hume, VA (US); Priyavadan Mamidipudi, Bristow, VA (US); Elizabeth A. Dakin, Great Falls, VA (US)

(73) Assignee: Catch The Wind, Inc., Manassas, VA (US)

(21) Appl. No.: 13/057,124

(22) PCT Filed: Feb. 5, 2010
(86) PCT No.: PCT/US10/23270

§ 371 Date: May 4, 2011

(51) Int. Cl. G01P 3/36; G01P 5/06

(52) U.S. Cl. 356/28.5; 73/861.85

(57) ABSTRACT

Methods and systems for collecting high-density wind velocity data for the inflow area of a wind turbine are presented. Wind turbines are provided with one or more wind velocity sensors that provide a plurality of wind velocity measurements to the turbine from various ranges and locations across the inflow. Sensors are proximate to the wind turbine. Sensors mounted on the turbine's nacelle work collaboratively to provide the wind velocity measurements. Sensors mounted on the turbine's hub spin with the turbine blades. Spatial and temporal wind mapping provides improved fidelity of data to the wind turbine control system.

### BACKGROUND

The disclosure relates to forecasting wind velocities and in particular to using laser Doppler velocimeters to forecast high-density wind velocities for wind turbine control.

Wind turbines harness the energy of the wind to rotate turbine blades. The blade rotation is used to generate electric power. However, because wind velocities constantly change, using a wind turbine or multiple wind turbines in a wind farm to generate a constant power supply requires adapting the operation of the wind turbine to the changing conditions of the wind. Additionally, the operation of a wind turbine may also need to be adapted in order to protect the turbine from damage from severe gusts of wind.

Wind turbines may be adaptively controlled using a turbine-mounted wind velocity sensor whose output informs a control system to modify the operation of the turbine. In response to an output of a wind velocity sensor, a wind turbine nacelle may be rotated into or out of alignment with the wind, thereby modifying the yaw of the turbine. The individual blades of the turbine may also be angled in response to the strength or speed of the wind, thus modifying the pitch of the turbine blades. Yaw and pitch control are crucial to the efficient and safe operation of a wind turbine. As wind turbines increase in size, other aerodynamic devices (such as flaps and tabs) will be used to maintain desired performance and avoid over stressing the blades and other components.

One example of a turbine-mounted wind velocity sensor is a turbine-mounted wind speed laser Doppler velocimeter (“LDV”). A wind speed LDV transmits light to a target region (e.g., into the atmosphere) and receives a portion of that light after it has scattered or reflected from the target region or scatterers in the target region. In atmospheric measurements, the target for this reflection consists of entrained aerosols (resulting in Mie scattering) or the air molecules themselves (resulting in Rayleigh scattering). Using the received portion of scattered or reflected light, the LDV determines the velocity of the target relative to the LDV.

In greater detail, a wind speed LDV includes a source of coherent light, a beam shaper and one or more telescopes. The telescopes each project a generated beam of light into the target region. The beams strike airborne scatterers (or air molecules) in the target region, resulting in one or more back-reflected or backscattered beams. In a monostatic configuration, a portion of the backscattered beams is collected by the same telescopes which transmitted the beams. The received beams are combined with reference beams in order to detect a Doppler frequency shift from which velocity may be determined.

An example of an LDV that may be used as a turbine-mounted wind velocity sensor is disclosed in International Application Publication No. WO/2009/134221 (“the '221 publication”), the entirety of which is hereby incorporated by reference. The LDV of the '221 application includes a plurality of transceiver telescopes that are remotely located from the LDV coherent light source.

As disclosed in an embodiment of the '221 publication, the disclosed LDV includes an active lasing medium, such as e.g., an erbium-doped glass fiber amplifier for generating and amplifying a beam of coherent optical energy and a remote optical system coupled to the beam for directing the beam a predetermined distance to a scatterer of radiant energy. The remote optical system includes “n” duplicate transceivers (where n is an integer that may be, for example, one, two or three) for simultaneously measuring n components of velocity along n noncolinear axes.

Also as disclosed in the '221 application, the optical fiber is used to both generate and wave guide the to-be-transmitted laser beam. A seed laser from the source is amplified and, if desired, pulsed and frequency offset, and then split into n source beams. The n source beams are each delivered to an amplifier assembly that is located within the n transceiver modules, where each of the n transceiver modules also includes a telescope. Amplification of the n source beams occurs at the transceiver modules, just before the n beams are transmitted through the telescope lens to one or more target regions. When the n source beams are conveyed through connecting fibers from the laser source to each of the n telescopes within the respective transceiver modules, the power of each of the n source beams is low enough so as not to introduce non-linear behaviors from the optical fibers. Instead, power amplification occurs in the transceiver module, just before transmission from the telescope. Consequently, fiber non-linear effects are not introduced into the system.

By using the LDV disclosed in the '221 application, wind velocities may be measured remotely with a high degree of accuracy. Because the source laser is split into n beams, the measurements taken along all of the n axes are simultaneous. Additionally, splitting the source beam into n beams does not necessarily require that the source laser transmit a laser with n times the necessary transmit power, because each of the n beams are subsequently power amplified before transmission. Additionally, the disclosed LDV has no moving parts, and is thus of reduced size and improved durability. Because of the light-weight and non-bulky nature of the LDV, the LDV of the '221 application is ideal for mounting on a wind turbine.

The advantages of speed and direction measurements from a turbine-mounted wind velocity LDV are described in detail in the '221 application. And while measurements generated by a single turbine-mounted wind velocity LDV are very useful and provide information for general yaw and pitch control of the turbine, more detailed data regarding the wind velocity across the inflowing air mass is necessary in order to more finely control the wind turbines. For example, at any given time, wind velocities may vary with respect to spatial dimensions. In the wind industry vertical spatial variation in the wind is commonly known as shear and is important in relation to both wind turbines and aircraft. Horizontal spatial variation in wind is commonly known as veer. Shear and veer may manifest at any given time and/or together should be accunted for in controlling a wind turbine. For example, the velocity of wind approaching a turbine blade at the apex of its rotation may differ significantly from the velocity of the wind approaching a turbine blade at the bottom of its rotation. Unless this difference is accounted for in the blade controls, there will be asymetric loading of the wind turbine. In order to compensate for the variation in wind velocities, the individual turbine blades on a single turbine are capable of changing pitch independently of each other. However, without sufficient data regarding apatial variations in wind velocities approaching the individual turbine blades, the turbine can not take full advantage of these control capabilities. In order to take advantage of these capabilities in turbine control, the collected wind velocity data must be of a sufficient spatial resolution and density. Methods for measuring high-density wind velocity data are therefore desirable.

What is needed, then, is a method and system for measuring high-density wind velocity data for accurate wind turbine control.

### BRIEF DESCRIPTION OF THE DRAWINGS

FIG. 1 illustrates a typical wind turbine generator;

FIGS. 2A-D illustrate a wind turbine with high-density wind velocity LDV sensors and a method for using the sensors in accordance with embodiments of the disclosed invention;

FIGS. 3A and 3B illustrate a wind turbine with a high-density wind velocity LDV sensor and a method for using the sensor in accordance with embodiments of the disclosed invention; and

FIGS. 4A and 4B illustrate a wind turbine with high-density wind velocity LDV sensors and a method for using the sensors in accordance with embodiments of the disclosed invention

### DETAILED DESCRIPTION

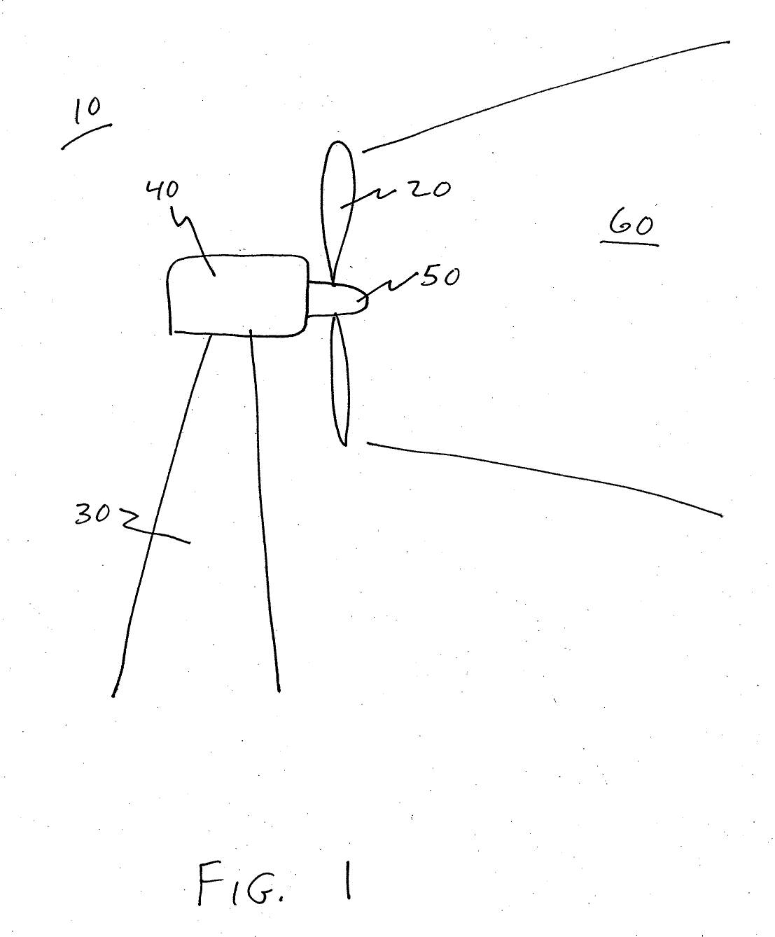

In order to provide the desired high-density wind velocity data for wind turbine control, wind velocities in atmospheric spaces in front of a wind turbine must be sampled at sufficient densities and frequency. FIG. 1 illustrates this concept. In FIG. 1, a wind turbine 10 is illustrated with blades 20 that rotate about a horizontal axis. The turbine includes a tower 30, a nacelle 40, a hub 50, and a plurality of blades 20. The nacelle 40 sits atop the tower 30 and allows for horizontal rotation or yawing of the turbine 10 so that the turbine 10 aligns with the wind direction. The blades 20 and hub 50 are attached to the nacelle 40 via an axle and together spin about a horizontal axis. The nacelle 40 that contains the drive-train and electric generator does not spin with the blades 20 and hub 50. The rotation of the blades 20 encompasses a disc-shaped area that extends equally above, below and to the sides of the nacelle 40. Accurate wind velocity measurements must therefore include measurements in an inflow region 60 in front of and including as much as possible of the disc-shaped area. The measurements are preferably independent of each other and cover locations within the inflow region 60 with sufficient density.

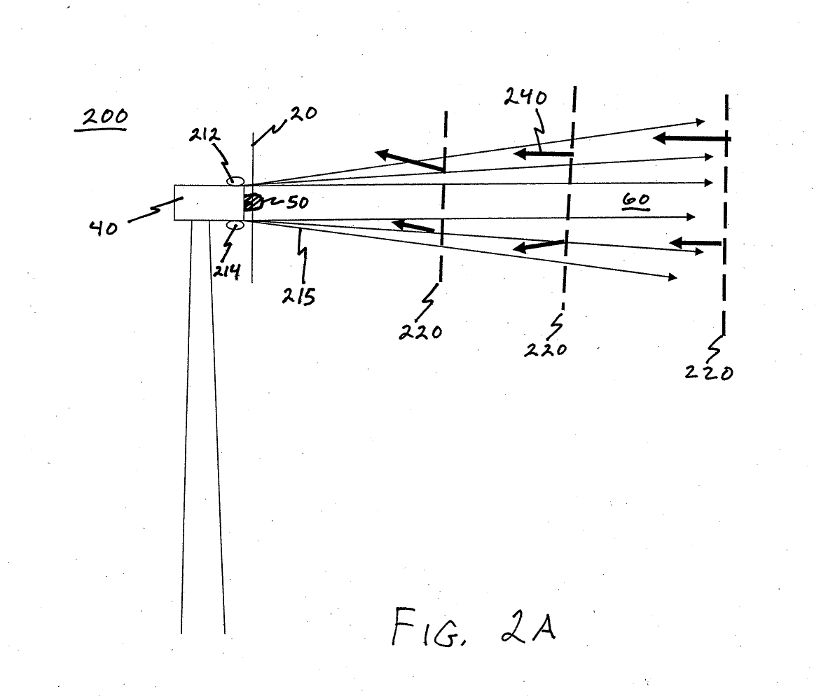

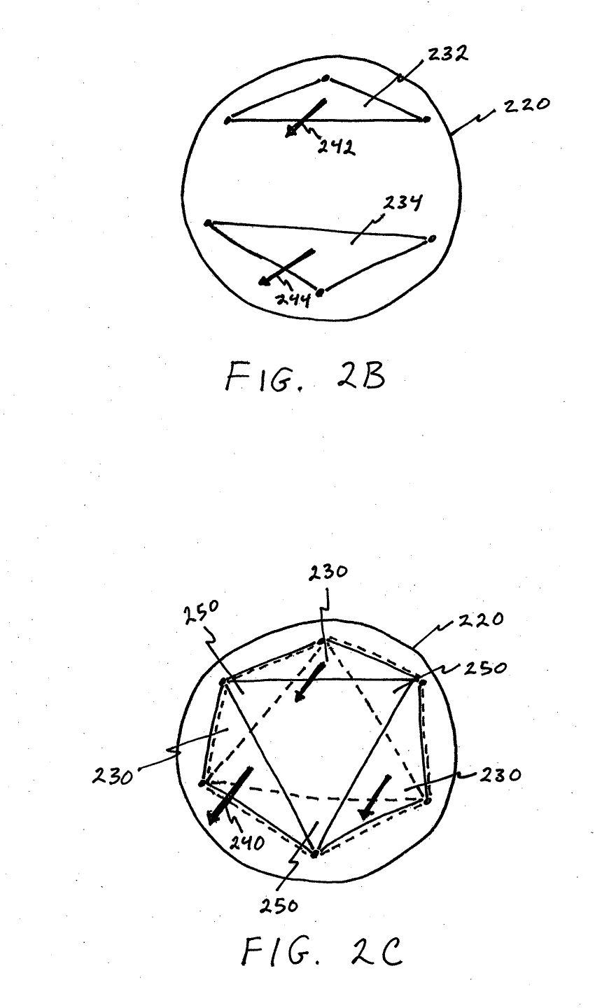

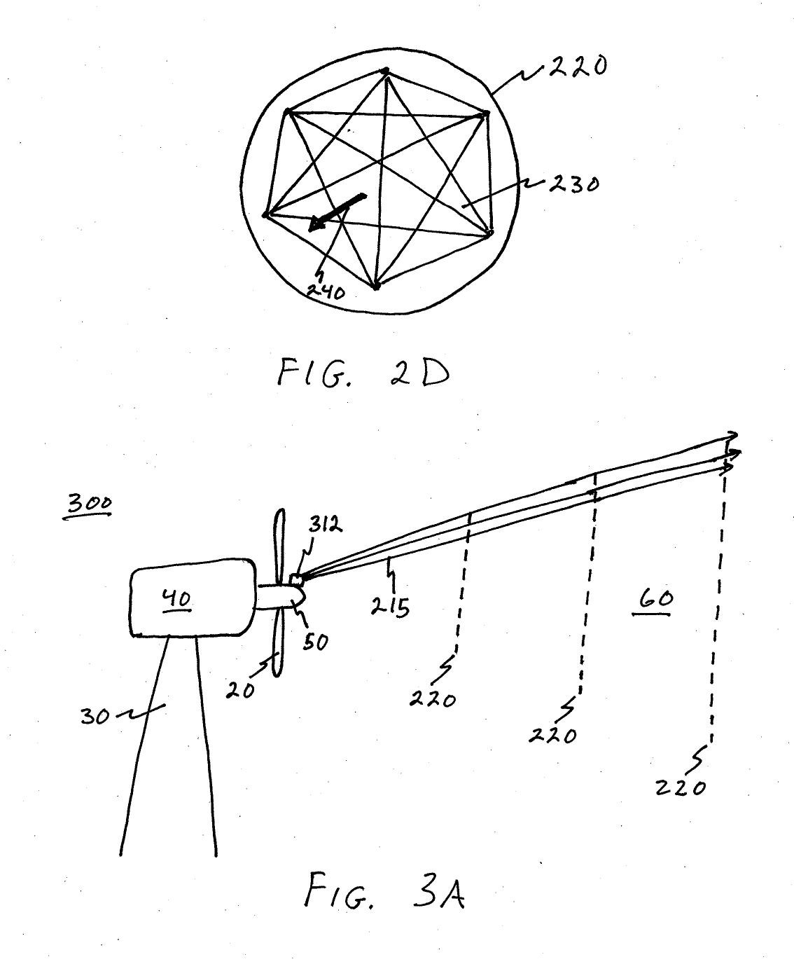

In order to provide the multiple data measurements in the inflow region 60 of FIG. 1, a plurality of wind velocity LDVs, such as those disclosed in the '221 application, are mounted on a turbine. In an embodiment, two wind velocity LDVs 212, 214 are mounted on the nacelle 40 of a wind turbine 200, as illustrated in FIG. 2A, or in some similar orientation or on some other stationary surface with relation to the wind turbine nacelle 40. The illustrated wind velocity LDVs 212, 214 each have three telescopes that are each oriented to take measurements along different beam paths 215. As a result, six separate and divergent beam paths 215 extend from the wind turbine 200, allowing for up to six measurements to be made at any given target plane 220 in front of the turbine 200. Measurements may be made simultaneously at different target planes 220. The measurements at known angles to each other may be used to determine three-dimensional wind vectors 240 at each of the target planes 220.

In FIG. 2B, an example configuration of measurement points in a target plane 220 is illustrated. In the example of FIG. 2B, the top three measurement points are from beams 215 originating from one of the wind velocity LDVs 212, while the bottom three measurement points are from beams 215 originating from the other of the wind velocity LDVs 214. If the two wind velocity LDVs 212, 214 each operated independently of the other, each would measure three one-dimensional vectors at points representing the vertices of a triangle. The three vectors for each triangle could be used to calculate a three-dimensional wind velocity for a point within the center of each triangle. Thus, one of the wind velocity LDVs 212 would determine a single three-dimensional wind velocity 242 at the target plane 220 (centered in a first triangle 232) while the other wind velocity LDV 214 would determine a second single three-dimensional wind velocity 244 at the target plane 220 (centered in a second triangle 234).

However, if the two wind velocity LDVs 212, 214 are configured to share data points, then the two sensors 212, 214 will generate a total of six data points from which up to 20 different triangles could be formed, each triangle resulting in its own calculated three-dimensional wind velocity. FIG. 2C illustrates how the six data points may be used to create three of the possible 20 different triangles 230 and locations of resulting calculated three-dimensional wind vectors 240 for each triangle 230. The three triangles 230 are illustrated using solid lines. An additional three triangles 250 are illustrated using dashed lines and are differentiated only for ease of visualization. Thus, six different three-dimensional wind velocities 240 could be determined using the triangles 230 illustrated in FIG. 2C.

FIG. 2D illustrates still additional possible triangles 230 derived from the same six data points. If each possible triangle configuration 230 is used, 20 different three-dimensional wind velocities 240 could be determined, with six velocities being near the outer boundary of the target area and an additional 14 velocities being closer to the center of the target area 220. This high-density real-time wind velocity measurement data is then used to characterize the real time spatial distribution of wind in the inflow and optimize the adjustment of the pitch or other aerodynamic control of, or along, individual turbine blades 20 as they sweep through the inflow according to the respective location of each blade to the measured data.

Of course, depending on a given application, not all 20 determined wind velocities need be used or even determined. For example, depending on the level of detail required for the blade pitch control of a given turbine, fewer than all 20 possible wind velocity determinations may need to be calculated. For example, if desired, only the six determined wind velocities illustrated in FIG. 2C could be used. Other combinations may be used as well.

The concept exemplified in FIGS. 2A-D is not limited to the use of just two three-telescope wind velocity LDVs. Additional sensors may be used to provide additional data points. Alternatively, the sensors may include different numbers of telescopes. For example, a four-telescope system could be used (using either a four-telescope sensor, two two-telescope sensors, four one-telescope sensors, or any combination thereof) to generate four data points and up to four unique triangles with four corresponding three-dimensional wind velocity measurements per target plane 220. A five telescope system could be used to produce up to ten unique triangles with ten corresponding three-dimensional wind velocity measurements per target plane 220. A seven telescope system could be used to produce up to 35 unique triangles with 35 corresponding three-dimensional wind velocity measurements per target plane 220. Combinatorial math is used to determine the maximum number of unique sets of three data points used of the total number of data points.

Referring again to FIG. 2A, the data measurements may be made nearly simultaneously (limited by the speed of light) at various target planes 220 that are each at different distances from the wind turbine. In FIG. 2A, three different target planes 220 are shown. Different numbers of target distances 220 may be used. With a sufficient number of target distances 220, the high-density wind velocity data can be used to accurately predict wind velocities at the wind turbine 200. More specifically, accurate predictions may be made of wind condition arrivals with respect to individual blade locations, thus allowing improved individual blade pitch or other aerodynamic control.

The embodiments illustrated in FIGS. 2A-D result in a plurality of independently measured wind velocities. No individually-determined wind velocity is dependent upon any other determined wind velocity. The independent measurements result in greater confidence in the resulting wind velocity map determinations. Additionally, for each target plane 220, wind measurements are made simultaneously. Thus time of measurement is not a variable in comparing wind velocities either across the inflow disc or from any given target plane 220.

Another embodiment for providing high-density wind velocity information is illustrated in FIGS. 3A and 3B. In FIG. 3A, a wind turbine 300 is illustrated with a tower 30, a nacelle 40, a hub 50 and a plurality of blades 20. In this embodiment, a wind velocity LDV 312 is mounted on the rotating hub 50 of the turbine 300. As a result, the wind velocity LDV 312 spins with the hub 50 and blades 20 scanning the inflow. In this illustration, the LDV 312 includes three telescopes and is oriented so that laser beams 215 are able to take multiple measurements around the sweep at the appropriate radius in one or more target planes 220 in the turbine's inflow region 60, as further illustrated in FIG. 3B. Thus, using just one wind velocity LDV 312, the wind turbine 300 is provided with a plurality of three-dimensional wind velocity vectors 240 at or near the perimeters of one or more different target planes 220.

The amount or density of data that could be collected using turbine 300 is significant. As an example, if the wind velocity LDV 312 on the turbine 300 collects data measurements at a frequency of 12 Hz, and if the turbine blades were spinning with a frequency of 12 revolutions per minute (“RPM”), then the LDV 312 would collect data for up to 60 three-dimensional wind vectors 240 per target distance 220 per revolution. With, for example, three target planes 220 being measured simultaneously, the turbine 300 would receive up to 180 three-dimensional wind vectors 240 per revolution. While data collected at a given target distance 220 will be time-shifted, as indicated by arrow 320 in FIG. 3B, the data collected for a given angle at multiple target planes 220 is simultaneous. Additionally, every measurement is independent of other measurements.

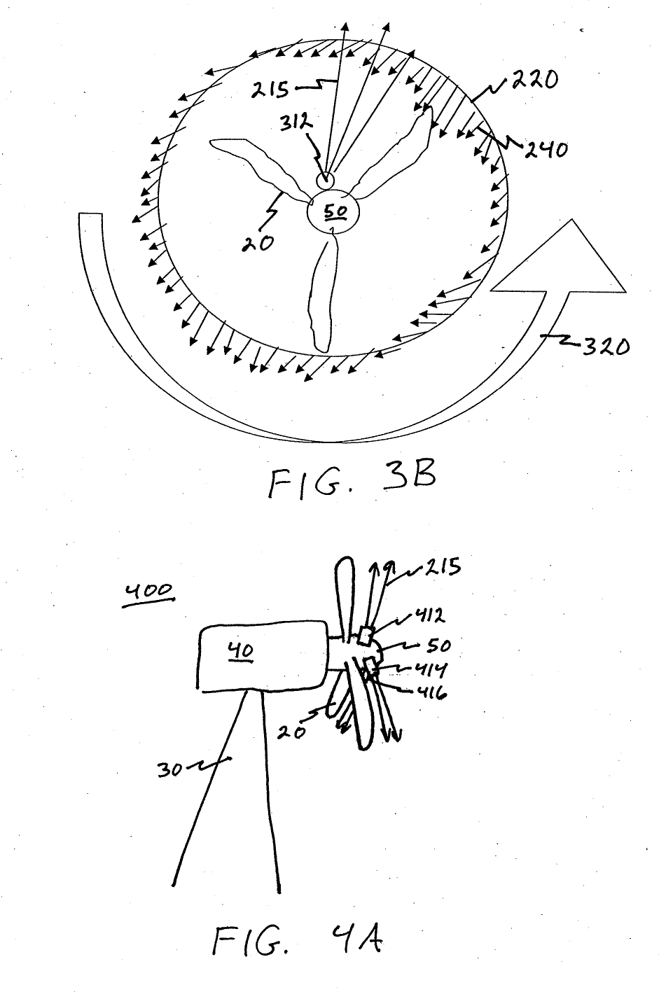

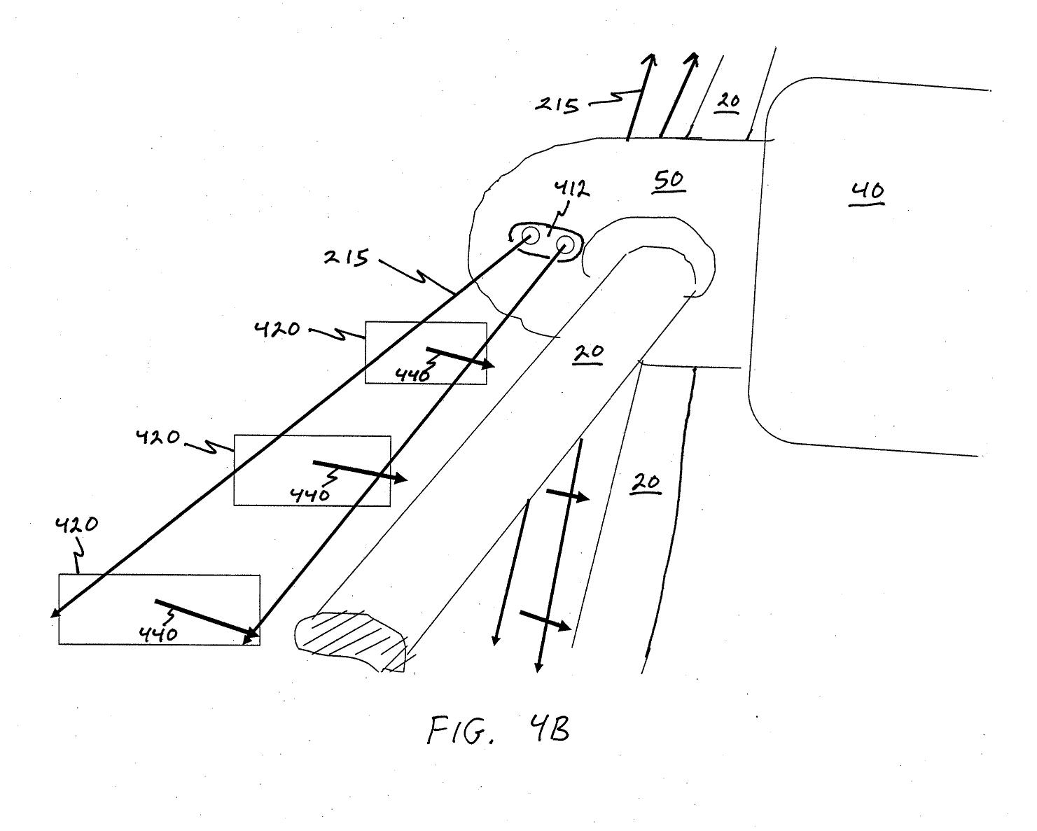

In yet another embodiment of mapping wind velocity measurements, measurements are made using wind velocity LDVs that direct lasers and take measurements from the hub along a beam path that is substantially parallel to the span of each turbine blade. An example is illustrated in FIGS. 4A and 4B. In FIG. 4A, a plurality of two-telescope wind velocity LDVs 412, 414, 416 are mounted on the hub 50 of the turbine 400. Each LDV 412, 414, 416 corresponds with one of the turbine blades 20. Therefore, a three-blade turbine 400 would include three two-telescope LDVs 412, 414, 416. Each LDV 412, 414, 416 is mounted so that its telescopes direct a beam 215 in front of and along the major axis of its corresponding turbine blade 20. Each LDV 412, 414, 416 then gathers wind measurement data immediately in front of the blade from different target planes 420 along the span length of the blade 20. For example, measurements may be taken at regular spatial intervals along the length of the blade 20 (e.g., every six feet). Each measurement along the length of a given blade 20 is made simultaneously. Therefore, the turbine 400 is provided with independent and simultaneous wind velocity data for wind that is about to arrive at each individual blade 20.

Because wind velocity measurements are made in the area directly in front of each blade 20, three-dimensional wind vectors are not necessary. In other words, only two telescopes per LDV 412, 414, 416 need be used. The two telescopes are oriented to project laser beams that are not colinear but that allow the determination of two-dimensional wind velocity vectors 440 for target planes 420 that are directly in front of the corresponding blade 20. The target planes 420, of course, rotate with the rotation of the LDVs 412, 414, 416 and blade 20. If three-dimensional wind vectors are desired, however, three telescopes per sensor may also be used.

Wind measurements may be made by the LDVs 412, 414, 416 as frequently as desired. Thus, at any given moment in time, the wind turbine 400 is provided with detailed incoming wind information for each blade 20, thereby allowing accurate control of the pitch and other devices of each individual blade 20. As the sophistication of blade aerodynamic control increases by the use of rapidly responding individual flaps and/or tabs controlled along the length of the blade 20, this span-wise data is invaluable to optimizing performance and controlling stress and vibration.

Using one or more of the disclosed embodiments, a high-density wind velocity profile may be collected for a wind turbine. The collection of many wind velocity measurements in the inflow region of a wind turbine allows for the accurate mapping and predicting of wind shear and veer in the measured region. Additionally, statistical analysis of measured wind velocities, shear, and veer can indicate the characteristics of turbulence approaching the turbine. Therefore, not only does the measured data provide information for the control of individual blade pitch for efficient or maximal power generation, but the measured data also provides data for turbulence intensity prediction, thus allowing protective measures to be taken to preserve the integrity of the wind turbine.

In addition to the high-density measurement embodiments described herein, wind turbines may also be mounted with additional long-range wind velocity LDVs for additional yaw control warning time forecasting and power output prediction. Thus, a wind turbine may include one or more long-range sensors as well as one or more sensors for the collection of high-density inflow data.

The above description and drawings should only be considered illustrative of embodiments that achieve the features and advantages described herein. Modification and substitutions to specific structures can be made. For example, although the embodiments have been described for use with LDVs, other wind velocity measurement devices that can determine two- and three-dimensional wind vectors may be used. Accordingly, the claimed invention is not to be considered as being limited by the foregoing description and drawings.

1-36. (canceled)

37. A method, comprising:
determining a plurality of wind vectors at each of one or more target planes, the one or more target planes being a predetermined distance from a wind turbine; and
determining, based on the plurality of wind vectors, wind velocity approaching individual blades of the wind turbine.

38. The method of claim 37, further comprising coupling a wind sensor to the wind turbine.

39. The method of claim 38, further comprising using a laser Doppler velocimeter as the wind sensor.

40. The method of claim 38, further comprising:
coupling the wind sensor to a nacelle of the wind turbine; and
using four transceiver telescopes to perform the determining the plurality of wind vectors,
wherein the plurality of wind vectors are three-dimensional wind vectors.

41. The method of claim 38, further comprising coupling the wind sensor on a hub of the wind turbine to determine a plurality of wind vectors at a perimeter of each of the one or more target planes.

42. The method of claim 41, further comprising determining at least sixty three-dimensional vectors per revolution of the wind turbine.

43. The method of claim 38, further comprising coupling the wind sensors to a hub of the wind turbine,
wherein the wind sensors are used to perform the determining the plurality of wind vectors, the determining being performed in front of and spanning a major axis of each of the blades of the wind turbine.

44. The method of claim 43, further comprising using one of the wind sensors with respect to each of the blades of the wind turbine.

45. The method of claim 44, wherein the plurality of determined wind vectors is a plurality of two-dimensional wind vectors representing wind speeds directly in front of each of the blades.

46. The method of claim 37, wherein each of the wind vectors is determined independently of other ones of the wind vectors.

47. A system, comprising:
a wind turbine having a nacelle, a hub, and a plurality of blades, the hub and plurality of blades being configured to rotate about a horizontal axis; and
a wind velocity measurement device located proximate to the wind turbine and configured to determine a plurality of wind vectors at each of one or more target planes, the target planes being a predetermined distance from the wind turbine, such that wind velocity approaching individual blades of the wind turbine is determined.

48. The system of claim 47, wherein the wind velocity measurement device is coupled to the wind turbine.

49. The system of claim 47, wherein:
the wind velocity measurement device comprises a laser Doppler velocimeter coupled to the nacelle of the wind turbine and includes four transceiver telescopes; and
the laser Doppler velocimeter is configured to use the four transceiver telescopes cooperatively to determine the plurality of wind vectors.

50. The system of claim 49, wherein the laser Doppler velocimeter is configured to determine three-dimensional parameters of the plurality of wind vectors from data measured at each of the one or more target planes by the four transceiver telescopes.

51. The system of claim 47, wherein the wind velocity measurement device is a laser Doppler velocimeter coupled to the hub of the wind turbine and oriented to determine the plurality of wind vectors at a perimeter of each of the one or more target planes.

52. The system of claim 51, wherein the laser Doppler velocimeter is configured to determine at least sixty three-dimensional parameters of the plurality of wind vectors per revolution of the wind turbine.

53. The system of claim 47, wherein the wind velocity measurement device is a laser Doppler velocimeter coupled to the hub of the wind turbine and oriented to determine the plurality of wind vectors at target planes in front of and spanning a major axis of each of the plurality of blades.

54. The system of claim 53, further comprising:
a plurality of the laser Doppler velocimeters, such that there is one of the laser Doppler velocimeters with respect to each of the plurality of blades.

55. The system of claim 54, wherein the laser Doppler velocimeters are configured to determine a plurality of two-dimensional parameters of the plurality of wind vectors representing wind speeds directly in front of each of the plurality of blades.

56. The system of claim 47, wherein the wind velocity measurement device is configured to determine each of the plurality of wind vectors independently of other ones of the plurality of wind vectors.
